(19) United States
(12) Patent Application Publication
(10) Pub. No.: US 2005/0050252 A1
(43) Pub. Date: Mar. 3, 2005

(54) Information processing apparatus

(76) Inventor: Shinji Kuno, Ome-shi (JP)

Correspondence Address: Blakely, Sokoloff, Taylor & Zafman LLP, 7th Floor, 12400 Wilshire Boulevard, Los Angeles, CA, 90025, US

(21) Appl. No.: 10/805,755

(22) Filed: Mar. 22, 2004

(30) Foreign Application Priority Data
Aug. 29, 2003 (JP) 2003-307643

(51) Int. Cl. G06F 13/00; G06F 13/40; G06F 15/00; G06F 15/76

(52) U.S. Cl. 710/100

(57) ABSTRACT

An information processing apparatus includes a first processor, a second processor, an application program, under control of the first processor, issuing a processing execution request to the second processor, an actual processing section, under control of the second processor, executing an application interface processing code defined by the second processor, and an interface that, when an execution request of the application interface processing is issued by the application program, sends the processing execution request to the actual processing section through a communication bus.

### CROSS-REFERENCE TO RELATED APPLICATIONS

This application is based upon and claims the benefit of priority from prior Japanese Patent Application No. 2003-307643, filed Aug. 29, 2003, the entire contents of which are incorporated herein by reference.

### BACKGROUND

1. Field The present invention relates to an information processing apparatus and, more particularly, to an information processing apparatus having a stream processor which executes code for processing stream data such as broadcast program data or the like.

2. General Background

Recently, information processing apparatuses such as personal computers, game machines and the like having multimedia functions have been developed. The information processing apparatuses can process various kinds of content data such as video data, audio data and the like.

Development of home network systems integrating various kinds of household electronic devices such as personal computers, game machines, TVs, audio devices and the like has also proceeded.

In the home network system, generally, a stream processor exclusively processing the stream data such as broadcast program data and the like is provided. In some cases, two processors (the CPU and the stream processor) execute dispersed processing.

On the other hand, in a case of developing software to implement specific functions about the stream data processing, independent software is constructed on each of the stream processor side and the CPU side. However, if system architecture and devices need to be added or changed, the software on the stream processor side and the software on the CPU side must be changed in accordance with the additions and changes in system architecture, which wastes time and incurs unnecessary costs.

Jpn. Pat. Appln. KOKAI Publication No. 9-297570 discloses a graphic display system which does not require redesigning and re-coding of a graphics library for various kinds of hardware units.

However, the system of this document does not include a stream processor or does not execute dispersed processing by two processors (the CPU and the stream processor). For this reason, the above-described problem cannot be solved with the technique of the above document.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary block diagram showing a configuration of a home network system according to an embodiment of the present invention;

FIG. 2 is an exemplary block diagram showing a configuration of a home server used in the home network system of FIG. 1;

FIG. 3 is an exemplary block diagram showing a configuration of a stream processor provided in the home server of FIG. 2;

FIG. 4 is an illustration showing a manner of transparently controlling execution of application interface (API) processing defined by the stream processor, from a CPU side;

FIG. 5 is an exemplary diagram showing a manner of allowing a stream processor to effectively execute transparent display (alpha blending) of graphic data;

FIG. 6 is an exemplary flowchart showing operations for the transparent display;

FIG. 7 is an illustration showing a manner of monitoring operation conditions of each processor by arranging a system control microcomputer;

FIG. 8 is an exemplary flowchart showing processing startup control of each processor by a system control microcomputer;

FIG. 9 is an exemplary flowchart showing monitoring operation conditions of each processor by a system control microcomputer;

FIG. 10 is an exemplary illustration showing a first connection manner in installing a network processor;

FIG. 11 is an exemplary illustration showing a second connection manner in installing a network processor; and

FIG. 12 is an exemplary illustration showing a manner of implementing high-speed access to a flash memory by connecting a PCI flash memory bridge onto a PCI bus.

### DETAILED DESCRIPTION

Embodiments of the present invention will be described below with reference to the drawings. For instance, according to one embodiment of the invention, an information processing apparatus comprises a first processor; a second processor; an application program, under control of the first processor, issuing a processing execution request to the second processor; an actual processing section, under control of the second processor, executing an application interface processing code defined by the second processor; and an interface that, when an execution request of the application interface processing is issued by the application program, sends the processing execution request to the actual processing section through a communication bus.

According to another embodiment of the invention, an information processing apparatus comprises a CPU; a communication bus; a bridge device coupled to the CPU and the communication bus, the bridge device includes a graphics controller to transmit graphic data; a stream processor coupled to the communication bus, the stream processor processing stream data; a video bus coupled to both the graphics controller and the stream processor; and means for transferring (i) graphics data from the graphics controller to the stream processor through the video bus and (ii) transparent display information designating a rectangular region in a drawing area and a transparency rate at transparent display of the graphic data on a screen from the graphics controller to the stream processor through the communication bus, under control of the CPU.

According to still another embodiment of the invention, an information processing apparatus comprises a first processor; a communication bus; a bridge device coupled between the first processor and the communication bus; a second processor coupled to the communication bus, the second processor processing stream data; and control logic coupled to the communication bus and which, when a power-on signal is detected, issues a reset signal to each of the second processor and the first processor through the communication bus and issues a reset release signal to the first processor after issuing a reset release signal to the second processor.

According to yet still another embodiment of the invention, an information processing apparatus comprises a first processor; a communication bus; a bridge device coupled between the first processor and the communication bus, the bridge device including a first Media Independent Interface/Media Dependant Interface (MII/MDI) processing section; and a second processor including a second MII/MDI processing section to communicate with the first MII/MDI processing section in communications with a network.

According to a further embodiment of the invention, an information processing apparatus comprises a communication bus; an interface coupled to the communication bus, the interface including a first Media Independent Interface/Media Dependant Interface (MII/MDI) processing section; and a second processor including a second MII/MDI processing section adapted for communications with the first MII/MDI processing section and a network.

According to still a further embodiment of the invention, an information processing apparatus comprises a CPU; a communication bus; a first bridge device coupled between the CPU and the communication bus; a stream processor coupled to the communication bus, the stream processor processing stream data; a flash memory; and a second bridge device coupled to the communication bus and the flash memory.

In the following description, certain terminology is used to describe features of the invention. For instance, the terms “entry”, “section” and “communications interface” are each representative of software and/or hardware configured to perform one or more functions. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory), a hard drive disk, or the like.

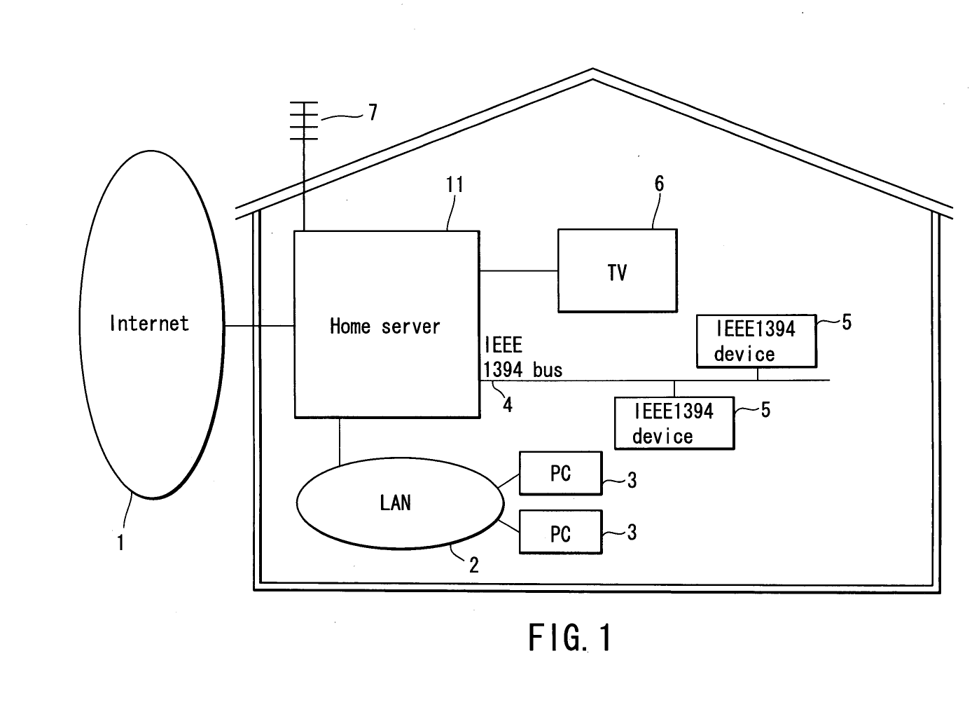

FIG. 1 shows a configuration of a home network system using an information processing apparatus according to an embodiment of the present invention. The information processing apparatus functions as a home server 11. The home server 11 is used to construct a home network system and is connected to various kinds of household electronic devices, such as personal computers (PCs) 3, various kinds of IEEE 1394 devices 5 (e.g., cameras), and a TV receiver 6 for example.

The home server 11 and the PCs 3 are connected via a wired or wireless LAN 2. The home server 11 and IEEE 1394 devices 5 are connected via an IEEE 1394 bus 4.

The home server 11 provides, for example, services relating to viewing of broadcast contents such as TV programs, Internet browsing, and the like to the PCs 3.

Specifically, the home server 11 connects the PCs 3 to Internet 1 to transmit and receive data between Web sites on the Internet 1 and the PCs 3. Moreover, the home server 11 is connected to a TV broadcast receiver interface 7 (e.g., antenna, cable connector, etc.) and can receive, for example, broadcast content data of TV programs provided by satellite broadcasting. The broadcast content data received by the home server 11 can be reproduced on the TV receiver 6 or can be transmitted to the PCs 3 via the LAN 2.

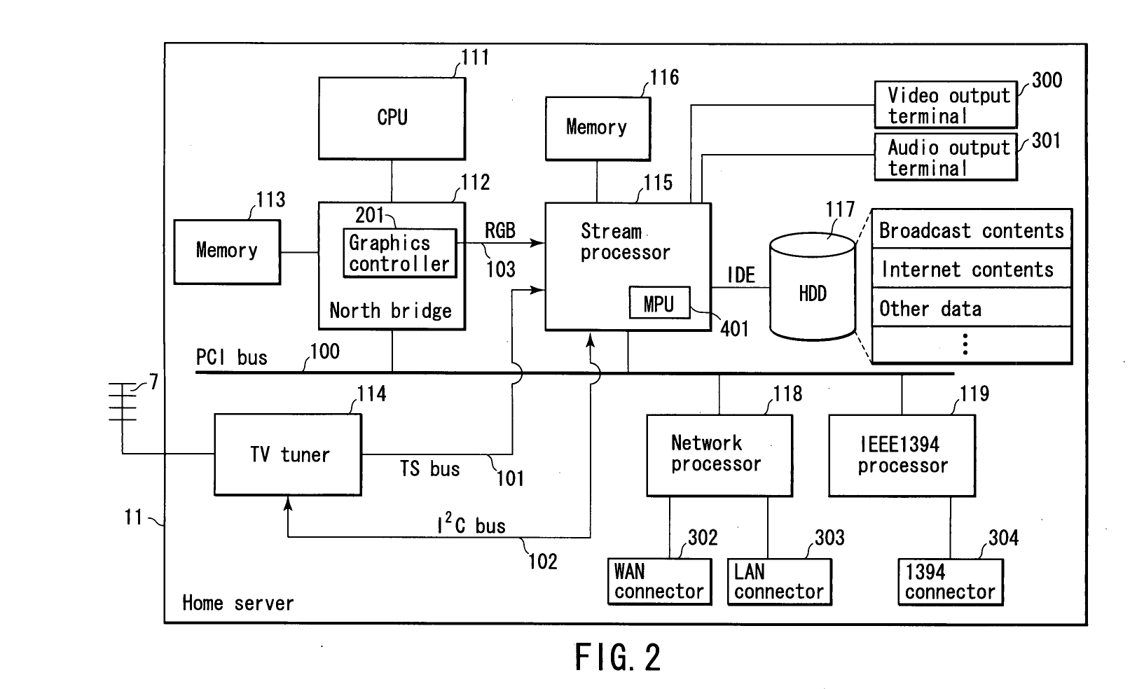

FIG. 2 shows an exemplary system configuration of the home server 11. The home server 11 includes a CPU 111, a north bridge 112, a memory 113, a TV tuner 114, a stream processor 115, a disk storage drive 117, a network processor 118, an IEEE 1394 processor 119 and the like.

The CPU 111 is a processor controlling the operations of the home server 11, executing an operation system and various kinds of application programs loaded from the disk storage drive 117 to the memory 113. The operation system has a file system and manages various kinds of content data stored in the disk storage drive 117 as files. In general, the CPU controls writing of data to the disk storage drive 117 and reading of the data therefrom. The CPU 111 is connected to a PCI bus 100 via the north bridge 112. The PCI bus 100 is employed for transfer of various kinds of data between the devices connected with the PCI bus 100.

The TV tuner 114 is a receiver adapted to receive broadcast content data associated with TV programs. The broadcast content data may be provided by satellite broadcasting for example. The broadcast content data provided by the satellite broadcasting contains compression-coded stream data called MPEG2 transport stream (TS). The TV tuner 114 is connected to the stream processor 115 via a bus (TS bus) 101 exclusively transferring the stream data (TS).

The stream data (TS) received by the TV tuner 114 is transferred to the stream processor 115 via the TS bus 101. The TV tuner 114 is also connected to the stream processor 115 via an I²C bus 102. The I²C bus 102 is used as a control bus for controlling the TV tuner 114 by the stream processor 115. For example, control information indicating the channel of the TV program which should be received is transferred from the stream processor 115 to the TV tuner 114 via the I²C bus 102.

The stream processor 115 is provided to execute code for processing relating to the stream data. An MPU 401 is built in the stream processor 115. The MPU 401 executes a driver program controlling the disk storage drive 117 and also a driver program processing the stream data.

The stream processor 115 is adapted to perform operations while executing inter-processor communication with the CPU 111. On the basis of a disk access request notified from the CPU 111 via the PCI bus 100, the stream processor 115 executes code for writing the data which is input via the PCI bus 100 and file management information to manage the data as files, in the disk storage drive 117. The stream processor 115 further executes code for reading data forming the files from the disk storage drive 117 to the PCI bus 100.

The file management information contains disk addresses of the data forming the files, access right information and the like. For example, in the UNIX® file system, the file management information corresponds to an “i-node”. The “i-node” is a data structure for managing each file/directory corresponding to the i-node. One i-node exists for one file. The CPU 111 manages each of the files stored in the disk storage drive 117 by using an i-node list. The “i-node list” is assembly of the i-nodes corresponding to each of all the files stored in the disk storage drive 117. Each i-node stored in the disk storage drive 117 is referred to by an i-node number corresponding to the “i-node”. The “i-node number” is a file identifier to uniquely identify each file. The i-node number is used as the index for indexing the i-node of the corresponding file from its file name or the like. Generally, the file name and the i-node number are made to have one-on-one correspondence to each other.

Input of the data to the disk storage drive 117 and output of the data therefrom are generally accomplished via the PCI bus 100. In a case of writing the broadcast contents to the disk storage drive 117, the data is transferred from the TV tuner 114 to the stream processor 115 via the TS bus 101. The PCI bus 100 is not used for the transfer of broadcast content data. Rather, it is only used for the transfer of file management information, namely information for managing the broadcast content data as files, from the CPU 111 to the stream processor 115.

A memory 116 is connected to the stream processor 115. The memory 116 is used as a work area of each of the programs executed by the stream processor 115 and also as a buffer memory for temporary storage of the stream data transferred from the TV tuner 114. The memory 116 is assigned to a part of a memory address space which the CPU 111 can access. Specifically, the memory 116 is shared by both the stream processor 115 and the CPU 111. The inter-processor communications between the stream processor 115 and the CPU 111 are made through the memory 116. Of course, the inter-processor communications between the stream processor 115 and the CPU 111 can also be executed by exchanging messages, via the PCI bus 100 or an exclusive inter-processor bus.

Moreover, the stream processor 115 has a function of decoding and reproducing the stream data of the broadcast contents stored in the disk storage drive 117, in accordance with instructions from the CPU 111. First, the stream processor 115 decodes the video data included in the stream data of the broadcast contents. Then, the stream processor 115 converts the decoded video data into video signals for TV output and supplies the video signals to the TV receiver 6 from a video output terminal 300. The audio data included in the stream data of the broadcast contents is also decoded and reproduced in the similar manner, and speech signals corresponding to the audio data are supplied to the TV receiver 6 or other audio devices from an audio output terminal 301.

The stream data, which the stream processor 115 can decode and reproduce, is the MPEG2 transport stream (TS).

The disk storage drive 117 includes a hard disk drive, which is connected to the stream processor 115 via an IDE bus. The disk storage drive 117 is used to store various kinds of content data (e.g., broadcast contents, Internet contents and the like). As all of items of the content data stored in the disk storage drive 117 are managed as files by the CPU 111, the CPU 111 can read these files of content data from the disk storage drive 117 by issuing a disk access request to the stream processor 115.

As described above, reproduction of the broadcast content data of the TV programs and the like is executed by the stream processor 115. For example, however, reproduction of the stream data such as the Internet contents utilizing the streaming technique is executed by the CPU 111. Specifically, a Web browser executed by the CPU 111 or a plug-in program added to the Web browser executes the reproduction of the Internet contents.

Thus, in the home server 11, two kinds of stream data (broadcast content and Internet contents) having differing data formats, are handled. The stream data of either type can be viewed on the TV receiver 6.

Viewing the stream data of the Internet contents on the TV receiver 6 will be assumed here. The stream data of the Internet contents is decoded by the CPU 111 and transmitted to a graphics controller 201 built in the north bridge 112. The graphics controller 201 converts the decoded stream data into display video signals (for example, RGB signals) and transmits the signals to the stream processor 115 via a video bus 103. The stream processor 115 converts the video signals input via the video bus 103 into video signals for TV output and outputs the video signals to the video output terminal 300.

In addition, the disk storage drive 117 can also be employed as a network drive. In this case, each item of the content data stored in the disk storage drive 117 can be referred to by each of the PCs 3 of the LAN 2.

Functioning as a router or access point, the network processor 118 is an exclusive processor for communication control to connect the home server 11 to the LAN 2 via a LAN connector 303 and to the Internet 1 via WAN connector 302. The network processor 118 is connected to the PCI bus 100. An MPU is also built in the network processor 118 such that the network processor 118 can establish inter-processor communication with the CPU 111 or the stream processor 115 as required.

The network processor 118 can acquire the content data stored in the disk storage drive 117 as files from the stream processor 115, by establishing inter-processor communications with the stream processor 115. Specifically, when the content data stored in the disk storage drive 117 is transmitted to the personal computer 3 on the LAN 2, the network processor 118 issues a disk access request to the stream processor 115 via the PCI bus 100. The network processor 118 can thereby read the stream data of the broadcast contents and the like requested by the personal computer 3 and transmit the stream data to the personal computer 3.

The IEEE 1394 processor 119 is a processor controlling the communication between the home server 11 and each of the IEEE 1394 devices 5, as shown in FIG. 1. IEEE 1394 processor is connected to the PCI bus 100 and an IEEE 1394 bus via IEEE 1394 connector 304. An MPU is also built in the IEEE 1394 processor 119 such that the IEEE 1394 processor 119 can make inter-processor communications with the CPU 111 or the stream processor 115.

The IEEE 1394 processor 119 can acquire the content data stored in the disk storage drive 117 from the stream processor 115, by making inter-processor communications with the stream processor 115. Specifically, when the content data stored in the disk storage drive 117 is transmitted to the IEEE 1394 device 5 on the IEEE1394 bus 4, the IEEE 1394 processor 119 issues a disk access request to the stream processor 115 via the PCI bus 100. The IEEE 1394 processor 119 can thereby read the stream data of the broadcast contents and the like requested by the IEEE 1394 device 5 of FIG. 1 and transmit the stream data to the IEEE 1394 device 5.

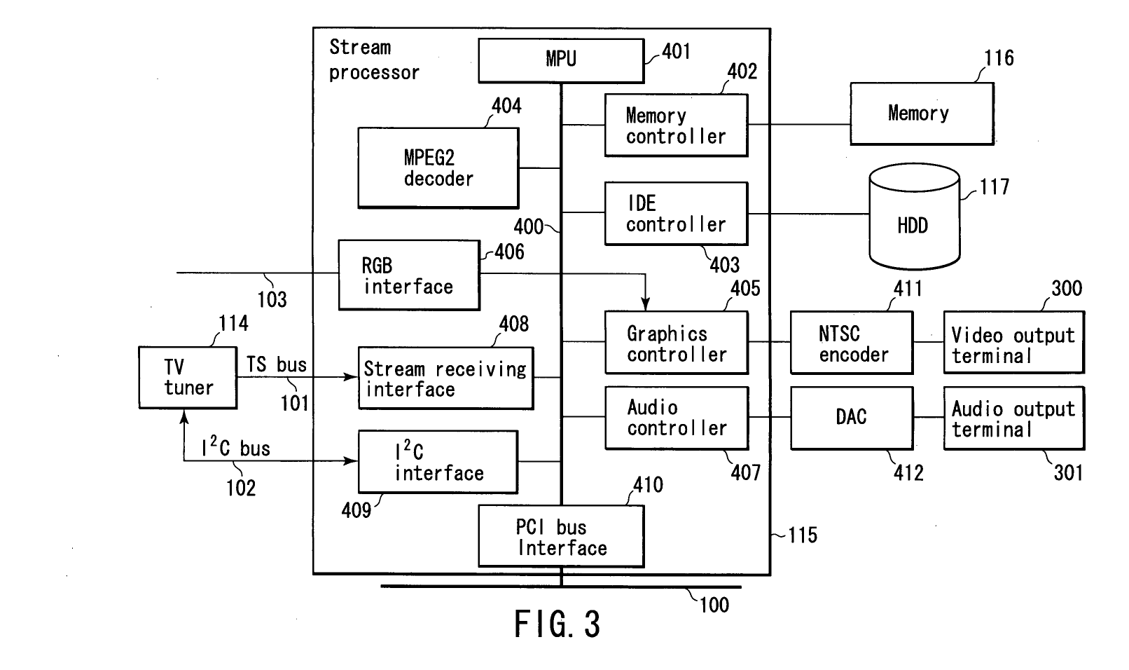

FIG. 3 shows an exemplary internal configuration of the stream processor 115.

An internal bus 400 of the stream processor 115 is connected to a memory controller 402, an IDE controller 403, an MPEG2 decoder 404, a graphics controller 405, an audio controller 407, a stream receiving interface 408, an I²C interface 409, and a PCI bus interface 410, besides the above-described MPU 401, as shown in the figure.

The memory controller 402 and the IDE controller 403 control access to the memory 116 and the disk storage drive 117, respectively. The MPEG2 decoder 404 decodes the MPEG2 transport stream. In the decoding, first, the video data and the audio data are separated from the MPEG2 transport stream. Then, decoding of the video data and decoding of the audio data are executed.

The graphics controller 405 converts the video data decoded by the MPEG2 decoder 404 into video signals for TV output (for example, digital video signals, analog video signals, DVI signals and the like). In a case of using an NTSC TV receiver, the video signals obtained by the graphics controller 405 are converted into NTSC signals by an NTSC encoder 411.

An RGB interface 406 is connected to the graphics controller 405. The RGB interface 406 receives the video data (RGB) which is input via a video bus 103. The video data (RGB) received by the RGB interface 406 is transmitted to the graphics controller 405, which converts the video data into the video signals for TV output (for example, digital video signals, analog video signals, DVI signals and the like).

The audio controller 407 is a sound source device converting the audio data decoded by the MPEG2 decoder 404 into sound data. The sound data obtained by the audio controller 407 is converted by a D/A converter (DAC) 412 from digital signals into analog signals, which are output from the audio output terminal 301.

The stream receiving interface 408 receives the stream data which is input from the TV tuner 114 via the TS bus 101. The stream data received by the stream receiving interface 408 is written to the memory 116 by the memory controller 402. The I²C interface 409 transmits the control information for channel selection to the TV tuner 114 via the I²C bus 102. The PCI bus interface 410 links the PCI bus 100 and the internal bus 400.

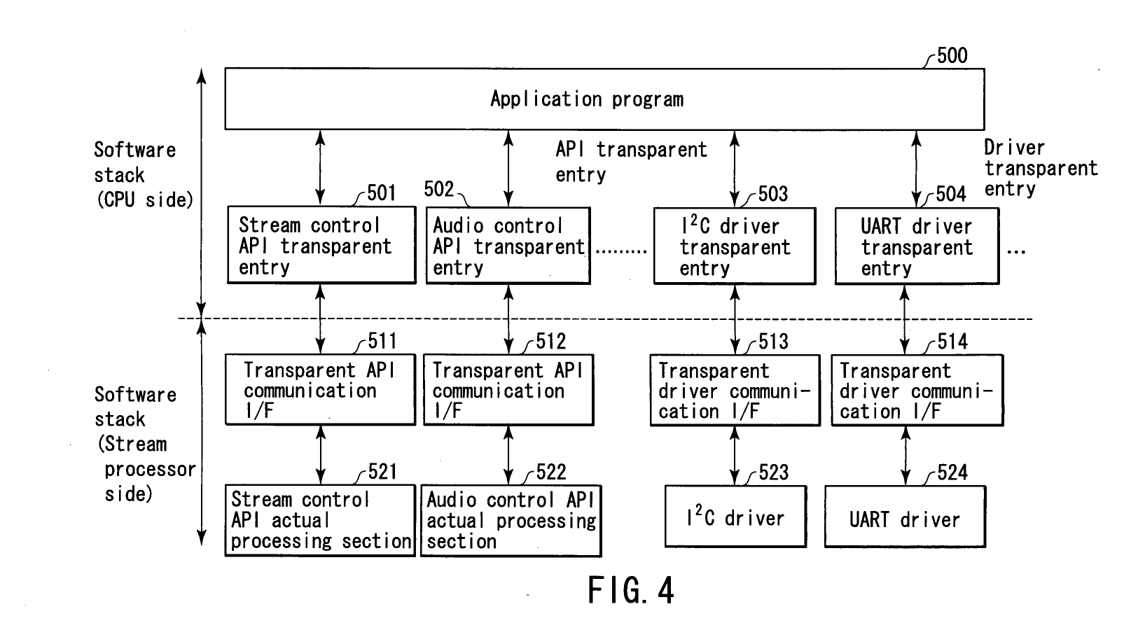

FIG. 4 is an exemplary illustration showing a manner of transparently controlling execution of application programming interface (API) processing defined by the stream processor 115, from the CPU 111 side.

As shown in the figure, an application program 500, a stream control API transparent entry 501, an audio control API transparent entry 502, an I²C driver transparent entry 503, a UART (Universal Asynchronous Receiver-Transmitter) driver transparent entry 504 are provided as a software stack of the CPU 111 side. Each of them is controlled by the CPU 111. In other words, there are two kinds of transparent entries, namely the transparent entry for the API and the entry corresponding to the device driver.

On the other hand, transparent API communication interfaces 511, 512, and transparent driver communication interfaces 513, 514 are provided as a software stack of the stream processor 115 side, so as to correspond to the transparent entries 501 to 504, respectively. Each of them 511-514 is controlled by the stream processor 115. In addition, a stream control API actual processing section 521, an audio control API actual processing section 522, an I²C driver 523, and a UART driver 524 are provided to correspond to the communication interfaces 511 to 514, respectively. Each of them 521-524 is controlled by the stream processor 115.

The application program 500 issues a processing execution request (or an access request) to the stream processor 115 and receives a response to the execution request sent back from the stream processor 115 side, under the control of the CPU 111. For example, the application program 500 executes a designated function, instructs the corresponding transparent entry to send the processing execution request including a related parameter to the stream processor 115, and receives the processing result (return value) sent from the stream processor 115 via the same transparent entry.

Each of transparent entries 501-504 does not perform so-called actual processing, but performs interface processing of the communication (I²C communication) on the PCI bus 100 between the CPU 111 and the stream processor 115.

When the request for execution of the stream control API processing is issued by the application program 500, the transparent entry 501 receives and sends the request to the communication interface 511 through the PCI bus 100 of FIG. 2. If a response to the processing execution request is sent from the communication interface 511, the transparent entry 501 sends the response to the application program 500. The communication interface 511 receives the processing execution request sent from the transparent entry 501 to the stream processor 115 through the PCI bus 100 of FIG. 2 and passes the request to the actual processing section 521. When the communication interface 511 receives a result of the processing execution from the actual processing section 521, the communication interface 511 sends the result of the processing execution to the transparent entry 501. The actual processing section 521 executes the stream control API processing code defined by the stream processor 115 and sends the result to the communication interface 511, in accordance with the processing execution request passed from the communication interface 511.

When the request for execution of the audio control API processing is issued by the application program 500, the audio control API transparent entry 502 receives and sends the request to the transparent API communication interface 512 through the PCI bus 100. If a response to the processing execution request is sent from the communication interface 512, the transparent entry 502 sends the response to the application program 500. The communication interface 512 receives the processing execution request sent from the transparent entry 502 to the stream processor 115 through the PCI bus 100 of FIG. 2 and passes the request to the actual processing section 522. When the communication interface 512 receives a result of the processing execution from the actual processing section 522, the communication interface 512 sends the result to the transparent entry 502. The actual processing section 522 executes the stream audio API processing code defined by the stream processor 115 and sends the result to the communication interface 512, in accordance with the processing execution request passed from the communication interface 512.

When the request for execution of the I²C driver interface processing is issued by the application program 500, the I²C driver transparent entry 503 receives and sends the request to the transparent driver communication interface 513 through the PCI bus 100 of FIG. 2. If a response to the processing execution request is sent from the communication interface 513, the transparent entry 503 sends the response to the application program 500. The communication interface 513 receives the processing execution request sent from the transparent entry 503 to the stream processor 115 through the PCI bus 100 of FIG. 2 and passes the request to the I²C driver 523. When the communication interface 513 receives a result of the processing execution from the I²C driver 523, the communication interface 513 sends the result of the processing execution to the transparent entry 503. The I²C driver 523 executes the I²C driver interface processing code defined by the stream processor 115 and sends the result of the processing execution to the communication interface 513, in accordance with the processing execution request passed from the communication interface 513.

When the request for execution of the UART driver interface processing is issued by the application program 500, the UART driver transparent entry 504 receives and sends the request to the transparent driver communication interface 514 through the PCI bus 100. If a response to the processing execution request is sent from the communication interface 514, the transparent entry 504 sends the response to the application program 500. The communication interface 514 receives the processing execution request sent from the transparent entry 504 to the stream processor 115 through the PCI bus 100 of FIG. 2 and passes the request to the UART driver 524. When the communication interface 514 receives a result of the processing execution from the UART driver 524, the communication interface 514 sends the result of the processing execution to the transparent entry 504. The UART driver 524 executes the UART driver interface processing code defined by the stream processor 115 and sends the result of the processing execution to the communication interface 514, in accordance with the processing execution request passed from the communication interface 514.

According to the manner shown in FIG. 4, in a case where two processors (CPU 111 and stream processor 115) executes dispersed processing, the CPU 111 side can transparently access the communication interface of the stream processor 115 side and the control of the API processing and the device driver processing in the stream processor 115 can be centralized on the CPU 111 side. Even when the CPU 111 is not connected, debugging can be performed in a closed state in the stream processor 115 though the processing speed is low. In addition, even if the scheme of connection between the processors is changed, the existing applications can be operated without problems with the same communication interface.

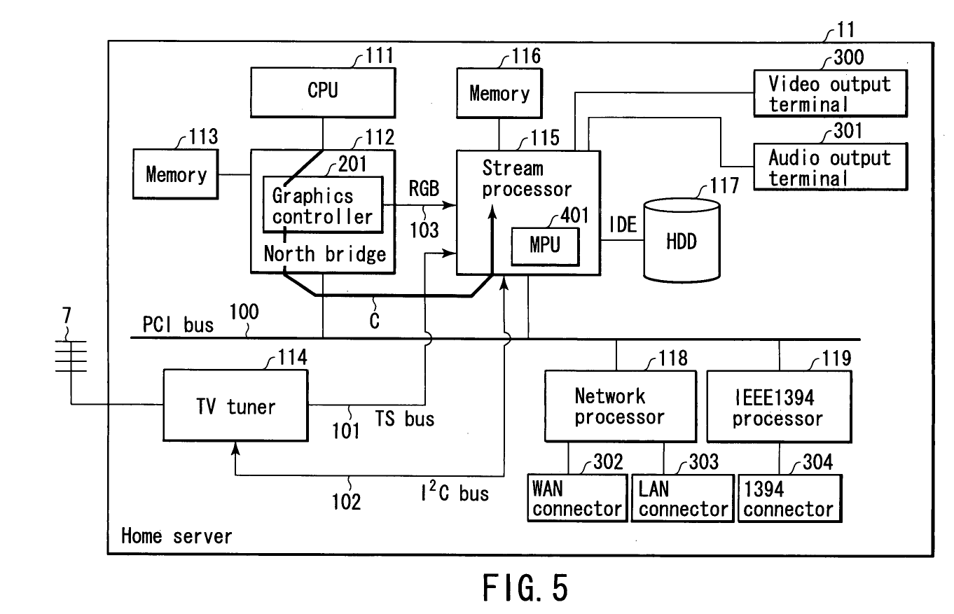

FIG. 5 is a diagram showing a manner of allowing the stream processor 115 to effectively execute transparent display (alpha blending) of graphic data.

When a video image generated by the stream processor 115 and a graphics image generated by the graphics controller 201 are to be superposed and displayed, transparent display of the graphics image needs to be executed. If such a request is made, a specific program operated under control of the CPU 111 transfers the graphic data from the graphics controller 201 to the stream processor 115 through the video bus 103. The program also transfers transparent display information designating a rectangular region (designated by, for example, coordinates (x1, y1) and (x2, y2)) in a drawing area and a transparency rate a in the transparent display of the graphic data on the screen, to the stream processor 115 through the PCI bus 100 as represented by symbol C of the figure. In this case, the stream processor 115 superposes the graphic data transferred through the video bus 103, on the video image to execute the transparent display, in accordance with the rectangular region and the transparency rate represented by the transparent display information transferred through the PCI bus 100.

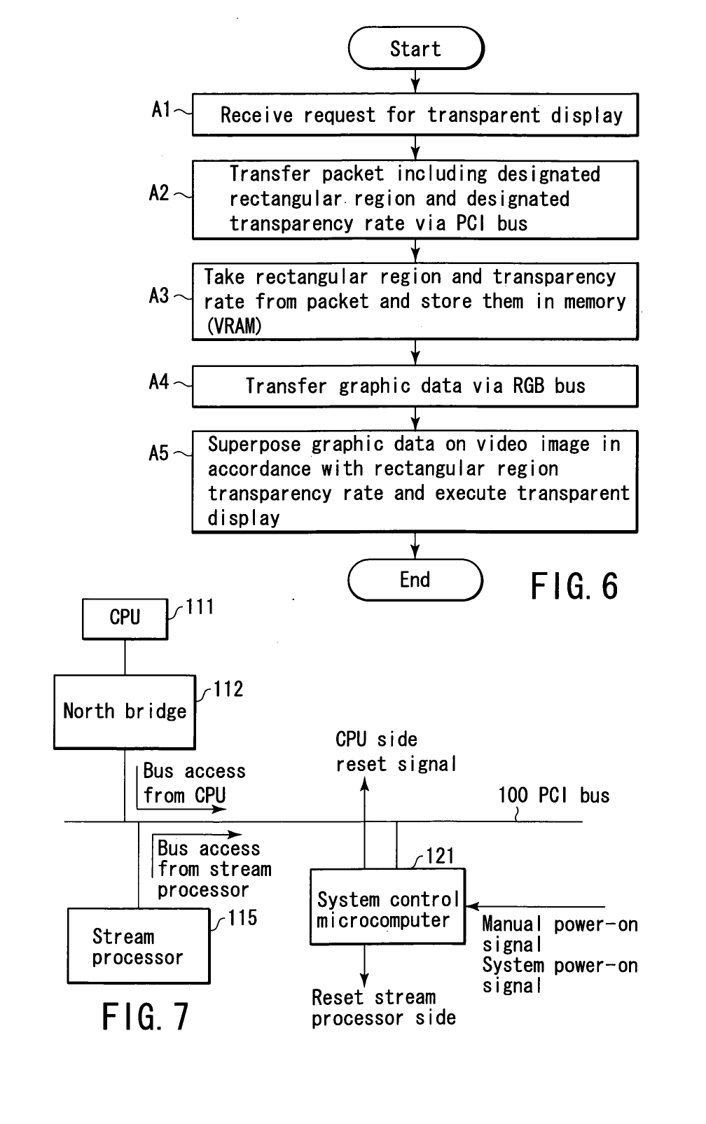

An operation for the transparent display will be explained here with reference to FIG. 6.

When the request for transparent display is received (block A1), a packet including the designated rectangular region and the designated transparency rate is generated and transferred to the graphics controller 201 via the PCI bus 100 (block A2). Thus, the graphics controller 201 of FIG. 5 takes the rectangular region and the transparency rate from the transferred packet and stores them in the memory 116 of FIG. 5 (block A3).

The graphics controller 201 transfers the graphic data via the video bus (RGB bus) 103 as shown in FIG. 5 (block A4).

The stream processor 115 superposes the graphic data transferred via the video bus (RGB bus) 103 of FIG. 5 on the video image in accordance with the rectangular region and the transparency rate and executes the transparent display (block A5).

According to the manners explained with reference to FIGS. 5 and 6, transparent display reducing the bus load can be efficiently performed. Specifically, the transparent display information that has required the bus width of the same capacity as each plane of RGB can be transferred at a very small data amount.

FIG. 7 is an illustration showing a manner of monitoring operation conditions of each processor by arranging a system control microcomputer.

A system control microcomputer 121 is connected to the PCI bus 100 and is capable of monitoring the operation conditions (power-on processing, reboot processing and shut-down processing) of each processor.

As for rising conditions of the system, the following procedures should be carried out: the stream processor 115 first starts up, and then the CPU 111 starts up after the startup of the stream processor 115 has completed. For this reason, when a manual power-on signal or a system power-on signal is detected, the system control microcomputer 121 issues a reset signal to the stream processor 115 and the CPU 111 through the PCI bus 100, and issues a reset release signal to the CPU 111 after issuing a reset release signal to the stream processor 115. At this time, the system control microcomputer 121 monitors the PCI bus 100, and determines whether or not the stream processor 115 has normally started up by confirming whether or not an access from the stream processor 115 to the PCI bus 100 has been issued.

In addition, the system control microcomputer 121 regularly monitors the PCI bus 100. If there is no access from the stream processor 115 or the CPU 111 to the PCI bus 100 after a certain period has passed, the system control microcomputer 121 can compulsorily reset and restart the stream processor 115 or the CPU 111.

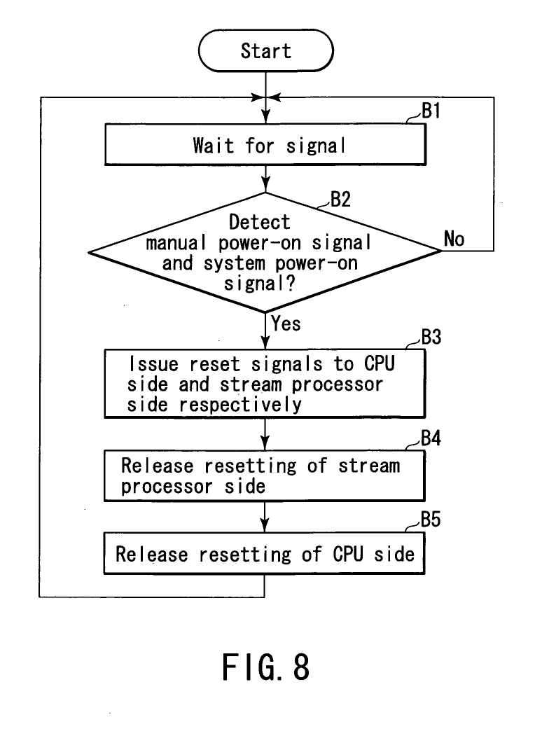

Processing the startup control of each processor by the system control microcomputer 121 will be explained here with reference to FIG. 8.

The system control microcomputer 121 waits for issue of signals (block B1). If the manual power-on signal and the system power-on signal are detected (Yes of block B2), a reset signal is issued to each of the CPU 111 side and the stream processor 115 side (block B3).

The system control microcomputer 121 releases resetting of the stream processor 115 side (block B4). After that, the system control microcomputer 121 releases resetting of the CPU 111 side (block B5).

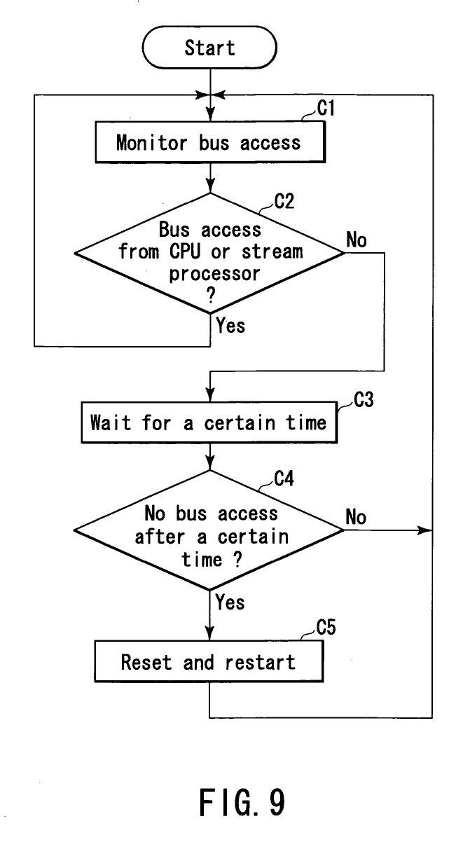

Next, monitoring the operation conditions of each processor by the system control microcomputer 121 will be explained with reference to FIG. 9.

The system control microcomputer 121 regularly monitors the PCI bus 100 (block C1). The system control microcomputer 121 determines whether or not the stream processor 115 or the CPU 111 accesses the PCI bus 100 (block C2). If there is no access to the PCI bus 100 after a certain time has passed (blocks C3, C4), the system control microcomputer 121 compulsorily resets and restarts the stream processor 115 and the CPU 111 (block C5).

According to the manners explained with reference to FIGS. 7 to 9, the stream processor 115 is reset, the operation of the stream processor 115 is confirmed and the CPU 111 is reset, at the startup of each processor. Therefore, stable startup of the system can be implemented. In addition, bus access from the CPU 111 and the stream processor 115 is monitored without special software. Therefore, a function corresponding to a watchdog timer can be implemented, and the reset processing can be easily performed at the runaway of the CPU 111 and the stream processor 115.

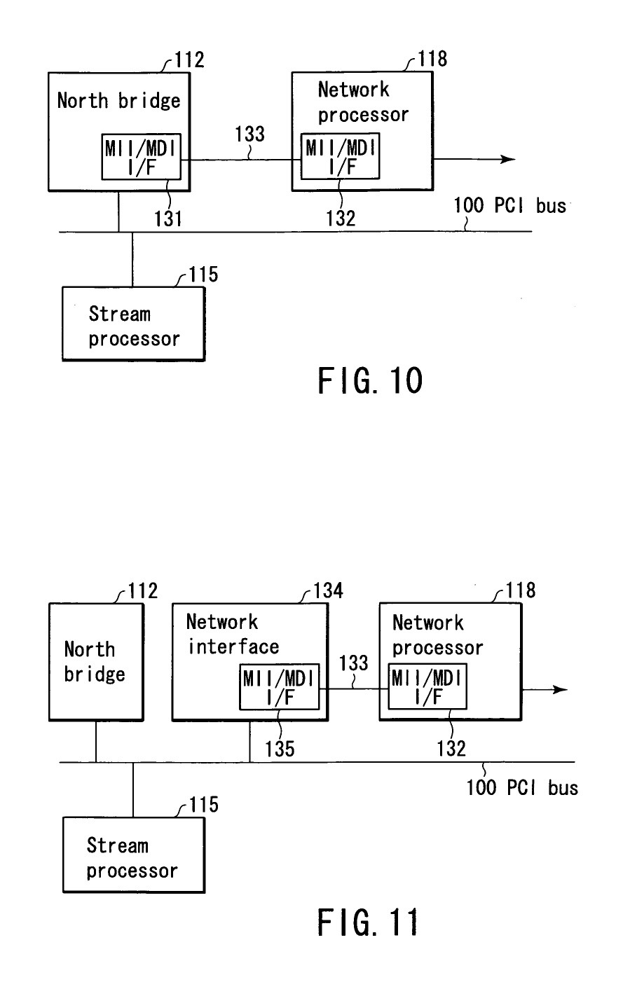

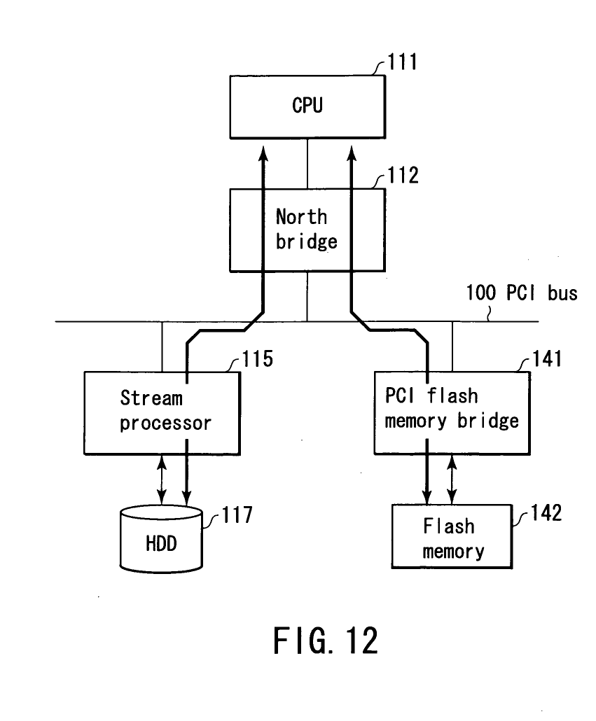

FIG. 10 is an illustration showing a first connection manner in installing the network processor 118. FIG. 11 is an illustration showing a second connection manner in installing the network processor 118.

In general, the network processor 118 is connected directly to the PCI bus 100 as shown in FIG. 2. In the connection, substantial changes of the hardware, changes in initialization of the BIOS, formation of new drivers and the like should be performed. Moreover, there is a problem that the traffic of the PCI bus for the network communication will be increased.

If a MII/MDI (Media Independent Interface/Media Dependent Interface) processing section 131 is implemented (e.g., mounted, built, etc.) in the north bridge 112, the network processor 118 in which a MII/MDI processing section 132 having the same specifications is implemented, is coupled to the north bridge 112 such that both the MII/MDI processing sections are connected by a line 133 as shown in FIG. 10. With this connection, the network processing of the router or the like can be executed by the network processor 118 side. In this case, the network processor 118 can be installed without making substantial changes in the hardware or software, by preparing the network interface for one port.

On the other hand, if the MII/MDI processing section 131 is not implemented in the north bridge 112, a network interface 134 having a MII/MDI processing section 135 is connected to the PCI bus 100, as shown in FIG. 11. Moreover, the network processor 118, in which the MII/MDI processing section 132 is implemented, is coupled to the network interface 134. Thus, both the MII/MDI processing sections are connected by the line 133. In this case, the network processor 118 can be installed without making substantial changes in the hardware or software, by preparing the network interface for one port.

In this configuration, IPv6/router processing code or the like is executed on the network processor 118 side. Therefore, the IPv6/router processing code does not need to be executed by the CPU 111 or the stream processor 115.

According to the manners explained with reference to FIGS. 10 and 11, the network processor 118 can be mounted while minimizing the changes in the application, by connecting the network interface to the outside not via the PCI bus 100, but via the MII/MDI.

FIG. 12 is an illustration showing a manner of implementing high-speed access to a flash memory by connecting a PCI flash memory bridge 141 onto the PCI bus 100.

In general data access, the CPU 111 accesses the disk storage drive 117 connected to the stream processor 115. However, frequently accessed data of high frequency in use that does not need to be read and written but only has to be read out, is not stored in the disk storage drive 117 but in a flash memory 142. In this case, the PCI flash memory bridge 141 executing bridge processing between the flash memory 142 and the PCI bus 100 is provided therebetween.

In this configuration, the CPU 111 can rapidly access the data in the flash memory through the north bridge 112 and the PCI flash memory bridge 141. In this case, the access to the data can be performed more rapidly than the network disk access through the stream processor 115, without putting load on the stream processor 115.

According to the manner explained with reference to FIG. 12, as for the frequently accessed data for reading use such as font data, dictionary data and the like, the CPU makes access not to the disk storage drive 117 connected to the stream processor 115, but to the flash memory 142 connected to the PCI flash memory bridge 141. Therefore, throughput of the entire system can be improved without putting load on the stream processor 115.

According to the present invention, as described above, burden on the software development can be reduced and each processor can efficiently execute processing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information processing apparatus comprising:
a first processor;
a second processor;
an application program, under control of the first processor, issuing a processing execution request to the second processor;
an actual processing section, under control of the second processor, executing an application interface processing code defined by the second processor; and
an interface that, when an execution request of the application interface processing is issued by the application program, sends the processing execution request to the actual processing section through a communication bus.

2. The information processing apparatus according to claim 1, wherein the second processor is a stream processor.

3. The information processing apparatus according to claim 1, wherein the first processor is a central processing unit (CPU).

4. The information processing apparatus according to claim 1, further comprising:
a driver, under control by the second processor, executing a device driver interface processing code defined by the second processor; and
an interface that, when an execution request of the device driver interface processing code is issued by the application program, sends the execution request to the driver through the communication bus.

5. An information processing apparatus comprising:
a CPU;
a communication bus;
a bridge device coupled to the CPU and the communication bus, the bridge device includes a graphics controller to transmit graphic data;
a stream processor coupled to the communication bus, the stream processor processing stream data;
a video bus coupled to both the graphics controller and the stream processor; and
means for transferring (i) graphics data from the graphics controller to the stream processor through the video bus and (ii) transparent display information designating a rectangular region in a drawing area and a transparency rate at transparent display of the graphic data on a screen from the graphics controller to the stream processor through the communication bus, under control of the CPU.

6. The information processing apparatus according to claim 5, wherein the stream processor superposes the graphic data transferred through the video bus on a video image, in accordance with the rectangular region and the transparency rate represented by the transparent display information transferred through the communication bus.

7. The information processing apparatus according to claim 5, wherein the communication bus is a Peripheral Component Internet (PCI) bus.

8. An information processing apparatus comprising:
a first processor;
a communication bus;
a bridge device coupled between the first processor and the communication bus;
a second processor coupled to the communication bus, the second processor processing stream data; and
control logic coupled to the communication bus and which, when a power-on signal is detected, issues a reset signal to each of the second processor and the first processor through the communication bus and issues a reset release signal to the first processor after issuing a reset release signal to the second processor.

9. The information processing apparatus according to claim 8, wherein the control logic is a system control microcomputer.

10. The information processing apparatus according to claim 8, wherein the first processor is a central processing unit, the second processor is a stream processor and the communication bus is a Peripheral Component Interconnect (PCI) bus.

11. The information processing apparatus according to claim 8, wherein the control logic monitors the communication bus and determines whether or not the second processor is normally started by confirming whether or not an access to the communication bus is issued by the second processor.

12. The information processing apparatus according to claim 11, wherein the control logic monitors the communication bus, and resets and restarts the second processor and the first processor if there is no access from any one of the second processor and the first processor to the communication bus after a certain time has passed.

13. An information processing apparatus comprising:
a first processor;
a communication bus;
a bridge device coupled between the first processor and the communication bus, the bridge device including a first Media Independent Interface/Media Dependant Interface (MII/MDI) processing section; and
a second processor including a second MII/MDI processing section to communicate with the first MII/MDI processing section in communications with a network.

14. The information processing apparatus according to claim 13, wherein the first processor is a CPU and the second processor is a network processor.

15. An information processing apparatus comprising:
a communication bus;
an interface coupled to the communication bus, the interface including a first Media Independent Interface/Media Dependant Interface (MII/MDI) processing section; and
a second processor including a second MII/MDI processing section adapted for communications with the first MII/MDI processing section and a network.

16. An information processing apparatus comprising:
a CPU;
a communication bus;
a first bridge device coupled between the CPU and the communication bus;
a stream processor coupled to the communication bus, the stream processor processing stream data;
a flash memory; and
a second bridge device coupled to the communication bus and the flash memory.

17. The information processing apparatus according to claim 16, wherein the CPU is adapted to access the flash memory through the first bridge device and the second bridge device.
